(19) United States
(12) Patent Application Publication
(10) Pub. No.: US 2018/0180459 A1
(43) Pub. Date: Jun. 28, 2018

(54) DISTANCE CALCULATION METHOD, FLOW VOLUME MEASURING METHOD, DISTANCE CALCULATION APPARATUS, AND FLOW VOLUME MEASURING APPARATUS

(71) Applicant: FUJITSU LIMITED, Kawasaki-shi (JP)

(72) Inventor: Hiroshi Takahashi, Kawasaki (JP)

(73) Assignee: FUJITSU LIMITED, Kawasaki-shi (JP)

(21) Appl. No.: 15/830,159

(22) Filed: Dec. 4, 2017

(30) Foreign Application Priority Data
Dec. 27, 2016 (JP) 2016-253315

(51) Int. Cl. G01F 13/00; G01F 15/06; G06F 3/0484; G06T 7/62; G06F 3/0488

(52) U.S. Cl. CPC G01F 13/006; G01F 15/068; H04N 5/23293; G06T 7/62; G06F 3/04883; G06F 3/04847

(57) ABSTRACT

Disclosed is a non-transitory computer-readable recording medium having stored therein a distance calculation program for causing a computer to execute a distance calculation process in a terminal having an imaging device and a touch panel. The distance calculation process includes detecting a first operation and a second operation on the touch panel in a display mode in which a captured image captured by the imaging device is displayed and a scale is set in the captured image; and executing the distance calculation process using the scale, based on a position of the first operation and a position of the second operation, to calculate a distance between a position on the captured image corresponding to the position of the first operation and a position on the captured image corresponding to the position of the second operation.

### CROSS-REFERENCE TO RELATED APPLICATIONS

This application is based upon and claims the benefit of priority of the prior Japanese Patent Application No. 2016-253315, filed on Dec. 27, 2016, the entire contents of which are incorporated herein by reference.

### FIELD

The disclosures discussed herein relate to a distance calculation method, a flow volume measuring method, a distance calculation apparatus, and a flow volume measuring apparatus.

### BACKGROUND

Flood prediction is considered as one of the most important factors for reducing flood damage caused by flooding of rivers. To predict flood, it is necessary to obtain the total rainfall and the river flow rate throughout the basin. With respect to the total rainfall, recently satellite observation rainfall and radar rainfall have been substituted for actual observation; however, with respect to river flow, actual observation is required, making it difficult to conduct observation in various locations.

Meanwhile, there is a flow rate observation technology based on image analysis (e.g., “Validation of flow rate observation using KU-STIV”, River Information Center, http://www.river.or.jp/01kenshuu/sympo/h26/img/report_08.pdf). This technology is to measure the flow velocity by photographing a river with fixed monitoring cameras; however, the technology requires expensive equipment as well as geometric correction. Hence, there are many restrictions such as in imaging angle and time, which may be a reason for preventing this technology from being widely used.

Further, a technology for detecting travel speed of a travel subject by photographing with a digital camera or the like possessed by an individual has been disclosed (e.g., Patent Document 1). However, the use of this technology is limited to a case where the size of the subject is assumed in advance; this technology is thus not appropriate for measuring flow rates of rivers.

### RELATED-ART DOCUMENT

### Patent Document

Patent Document 1: Japanese Laid-open Patent Publication No. 2006-140605

### SUMMARY

According to an aspect of embodiments, there is a provision for a non-transitory computer-readable recording medium having stored therein a distance calculation program for causing a computer to execute a distance calculation process in a terminal having an imaging device and a touch panel. The distance calculation process includes detecting a first operation and a second operation on the touch panel in a display mode in which a captured image captured by the imaging device is displayed and a scale is set in the captured image; and executing the distance calculation process using the scale, based on a position of the first operation and a position of the second operation, to calculate a distance between a position on the captured image corresponding to the position of the first operation and a position on the captured image corresponding to the position of the second operation.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration example of a system according to an embodiment;

FIG. 2 is a diagram illustrating an example of installation of an AR marker on a river;

FIG. 3 is a diagram illustrating an example of AR marker management information;

FIG. 4 is a diagram illustrating an example of a hardware configuration of a terminal;

FIG. 5 is a diagram illustrating an example of a hardware configuration of a river information processing apparatus;

FIG. 6 is a flowchart illustrating a process example of an embodiment;

FIG. 7 is a diagram (part 1) depicting an example of a screen of a terminal;

FIG. 8 is a diagram (part 2) depicting an example of a screen of a terminal;

FIG. 9 is a diagram (part 3) depicting an example of a screen of a terminal;

FIG. 10 is a diagram (part 4) depicting an example of a screen of a terminal;

FIG. 11 is a diagram (part 5) depicting an example of a screen of a terminal;

FIG. 12 is a diagram (part 6) depicting an example of a screen of a terminal;

FIG. 13 is a diagram (part 7) depicting an example of a screen of a terminal; and

FIG. 14 is a diagram illustrating another configuration example of the system.

### DESCRIPTION OF EMBODIMENTS

One aspect of embodiments may provide a technology of calculating a distance by a process performed on a terminal.

The following illustrates an embodiment with an example of flow measurement of a river; however, the embodiment may be applied to other examples having different purposes for measuring physical distance, velocity and the like.

Configuration

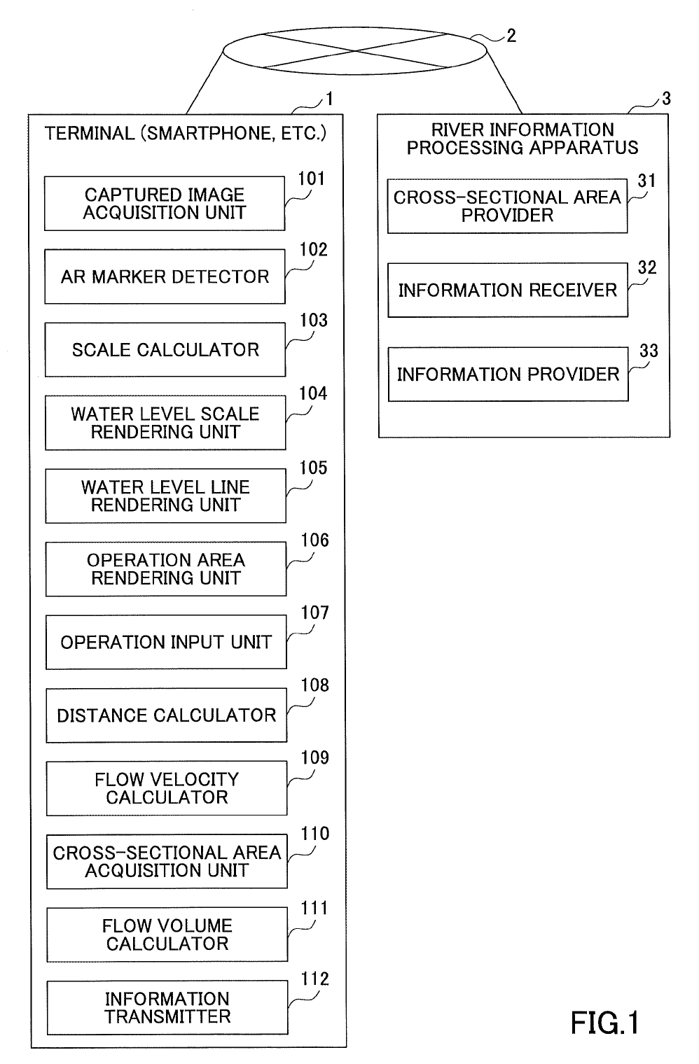

FIG. 1 is a diagram illustrating a configuration example of a system according to an embodiment. In FIG. 1, a terminal 1 such as a smartphone possessed by a partner in hydrologic measurement is coupled to a river information processing apparatus 3 through a network 2 such as the Internet, to enable mutual data communication between the terminal 1 and the river information processing apparatus 3.

The terminal 1 includes a captured image acquisition unit 101, an AR marker detector 102, a scale calculator 103, a water level scale rendering unit 104, a water level line rendering unit 105, and an operation area rendering unit 106. Further, the terminal 1 includes an operation input unit 107, a distance calculator 108, a flow velocity calculator 109, a cross-sectional area acquisition unit 110, a flow volume calculator 111, and an information transmitter 112.

The captured image acquisition unit 101 has a function to acquire an image (i.e., captured image) captured by a camera function of the terminal 1, render the captured image and display the rendered image on a screen.

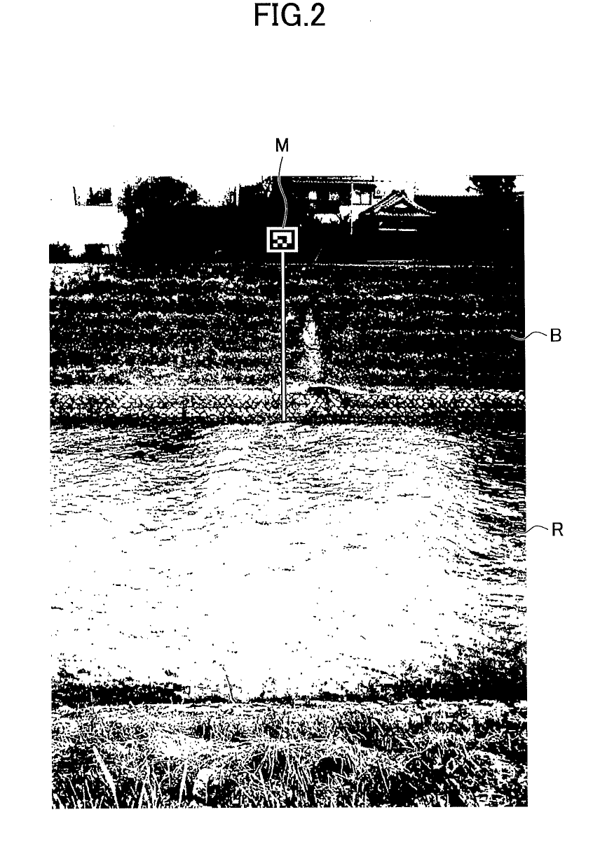

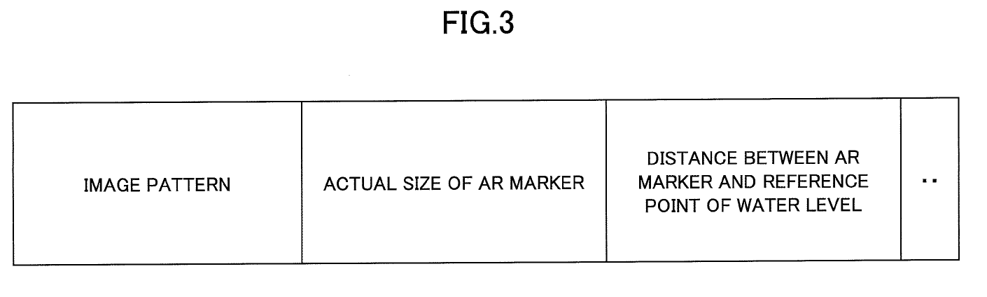

The AR marker detector 102 has a function to detect an augmented reality (AR) marker having a characteristic pattern from among the acquired captured images. FIG. 2 illustrates an example of an AR marker installed in a river, and an AR marker M depicting a pattern distinguishable from other landscape is attached to a support pole or the like such that the AR marker M is fixed to a position above an area of water flow of the river R. The area directly under the AR marker corresponds to a portion measuring the water level and the flow velocity; it is preferable that in this area the water level be clearly distinguished by an edge of a water surface similar to the edge of a bank B. FIG. 3 illustrates an example of AR marker management information retained inside the terminal 1. The AR marker management information includes an image pattern, the actual size of an AR marker, a distance (a distance in the vertically downward direction) between the AR marker (e.g., the center of the AR marker) and a reference point of the water level (the point at the water level of 0).

Referring back to FIG. 1, the scale calculator 103 has a function to calculate a scale that is a ratio of the size of the detected AR marker on the image to the actual size of the AR marker of the AR marker management information (FIG. 3), based on the size of the detected AR marker on the image and the actual size of the AR marker from the AR marker management information. The size of the AR marker on the image is represented by, for example, the number of pixels. The actual size of the AR marker is represented by, for example, centimeters. In the following, a scale is defined as a ratio of the size on the image to the actual size (e.g., pixel/cm); however, the scale may alternatively be defined as a ratio of the actual size to the size on the image (e.g., cm/pixel).

The water level scale rendering unit 104 is configured to render a calibrated water level measurement scale display downward from the lower end of the AR marker on the image, based on the calculated scale and the distance between the AR marker in the AR marker management information (FIG. 3) and the reference point of the water level, and superimposes the scale display on the captured image. A specific example of the water level measurement scale display is illustrated in a description of operations.

The water level line rendering unit 105 has a function to render a water level line display with a given position of the rendered water level measurement scale display as an initial position to superimpose the water level line display on the captured image and the water level measurement scale display. The initial position may be predetermined as a relative position in a range from the lower end of the AR marker to the reference point of the water level of 0 or may be determined randomly in that range. A specific example of scale display for measuring the water level is illustrated in a description of operations. In addition, the water level line rendering unit 105 may detect the edge of the water surface from the captured image by an image analysis process to estimate the water level line, or may render the water level line display with the detected edge of water surface as the initial position.

The operation area rendering unit 106 has a function to render an operation area (or an operation line) on the screen serving as a guide for operation input and superimpose the rendered operation area based on the rendered water level line display. Note that the operation area rendering unit 106 may display, instead of the operation area, symbols subject to slide operation (drag operation).

In the present embodiment, a floating object such as debris on the surface of a river is focused on, and a travel distance of the floating object is measured by an operation input by the operator, a travel time is measured by the timing of the input operation, and a flow velocity is obtained based on the travel distance and the travel time. Accordingly, the parts of the screen where the operation input is performed is limited to the part where the scale is identified (the part directly under the AR marker and a part extending in a horizontal direction from the AR marker), and the operation area is superimposed in order to clarify that operation range. Note that the operation area or operation line to be rendered is merely used as a guide, and is not strictly indicating that an operation input may only be received along the operation area. However, an operation input to a position significantly away from the operation area (an operation input to a position deviated from an area centered on the operation area) may fail to accurately represent flow velocity; therefore, the operation area rendering unit 106 may be configured not to receive such an input.

The operation input unit 107 has a function to detect an operation input position in a vertical direction at the time of input of the water level line based on a coordinate signal from a device such as a touch panel disposed on the surface of the screen of the terminal 1. Further, the operation input unit 107 also has a function to detect, at the time of input to the operation area (including a case of a symbol), the operation input position in a horizontal direction corresponding to a travel start point of the floating object and the operation input position in the horizontal direction corresponding to a travel end point of the floating object. Note that the operation input unit 107 also acquires timing (time information) at which the operation input unit 107 has detected the operation input position corresponding to the travel start point and the operation input position corresponding to the travel end point, respectively.

The distance calculator 108 has a function to calculate a travel distance from the operation input position corresponding to the travel start point detected at the time of input to an operation area (including a case of a symbol) and the operation input position corresponding to the travel endpoint. That is, the distance calculator 108 calculates a travel distance of a floating object or the like on a river by applying a scale to the difference (pixel value) between the position of the travel start point and the position of the travel end point on the screen. In scale applications, in a case where a scale is defined in pixels/cm, the difference in position is divided by the scale; in a case where a scale is defined in cm/pixel the position difference is multiplied by the scale.

The flow velocity calculator 109 has a function to calculate the flow velocity from the calculated travel distance, the time difference between the timings of the operation input corresponding to the travel start point and the operation input corresponding to the travel end point. That is, the flow velocity calculator 109 calculates the flow velocity by dividing the travel distance by the time difference of the operation inputs.

The cross-sectional area acquisition unit 110 has a function to acquire a river cross-sectional area at a corresponding position from the river information processing apparatus 3 based on the position information of the terminal 1 acquired by the global positioning system (GPS) function of the terminal 1 or the like. Note that the position information of the terminal 1 may be acquired by another method (e.g., a method of acquiring position information based on radio wave intensity from surrounding known radio base stations).

The flow volume calculator 111 has a function to calculate the flow velocity of the river at the position from the calculated flow velocity and the acquired river cross sectional area. That is, the flow volume calculator 111 calculates a flow volume by multiplying the flow velocity by the cross-sectional area of the river.

The information transmitter 112 has a function to transmit, as information of measurement results, the calculated flow volume, the position information of the measurement, the measurement date and time, and the image of the river at the time of measurement as required, to the river information processing apparatus 3.

The river information processing apparatus 3 includes a cross-sectional area provider 31, an information receiver 32, and an information provider 33. The cross-sectional area provider 31 has a function to provide information on a cross-sectional area of a river in a corresponding position in response to a request specifying the position information from the terminal 1. The information on the river cross sectional area is measured in advance by an administrative institution or the like managing a river, and such information is stored in a database.

The information receiver 32 has a function to receive the information on the measurement results from the terminal 1. Information on the received measurement results is accumulated in a database or the like.

The information provider 33 has a function to provide information such as flood prediction and the like performed based on the collected information on the measurement results to the residents or the like of the corresponding area via the Internet or the like.

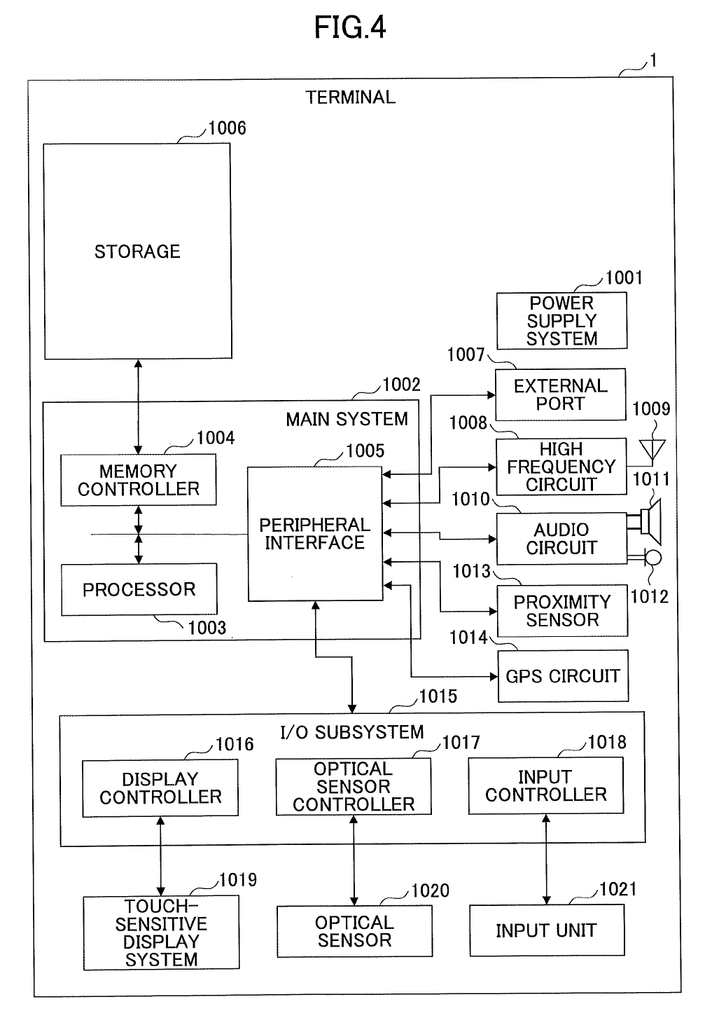

FIG. 4 is a diagram illustrating a hardware configuration example of the terminal 1, which indicates a configuration of a general smartphone or the like. In FIG. 4, the terminal 1 includes a power supply system 1001, a main system 1002 including a processor 1003, a memory controller 1004, a peripheral interface 1005, and a storage 1006. The terminal 1 further includes an external port 1007, a high frequency circuit 1008, an antenna 1009, an audio circuit 1010, a speaker 1011, a microphone 1012, a proximity sensor 1013, and a global positioning system (GPS) circuit 1014. The terminal 1 still further includes an input/output (I/O) subsystem 1015 including a display controller 1016, an optical sensor controller 1017, and an input controller 1018, and includes a touch-sensitive display system (touch panel) 1019, an optical sensor 1020, and an input unit 1021.

The functions of the terminal 1 described in FIG. 1 are implemented by executing a predetermined program in the processor 1003. The program may be acquired via a recording medium, may be acquired via a network, or may be embedded in a ROM.

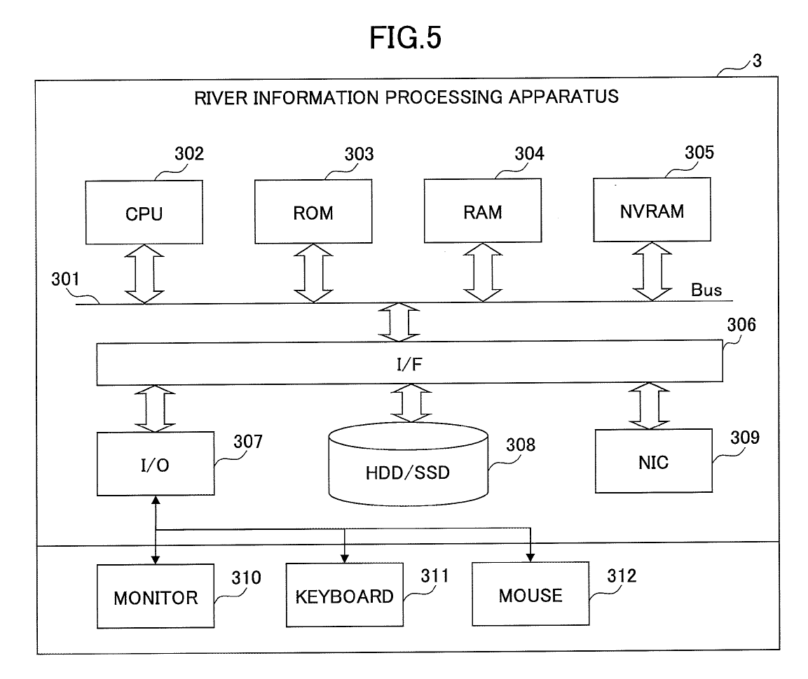

FIG. 5 is a diagram illustrating a hardware configuration example of the river information processing apparatus 3, which indicates a configuration of a general computer apparatus. In FIG. 5, the river information processing apparatus 3 includes a central processing unit (CPU) 302, a read only memory (ROM) 303, a random access memory (RAM) 304, and a nonvolatile random access memory (NVRAM) 305. The river information processing apparatus 3 includes an interface (I/F) 306, an input/output (I/O) device 307, a hard disk drive (HDD)/solid state drive (SSD) 308 coupled to the I/F 306, and a network interface card (NIC) 309. The river information processing apparatus 3 further includes a monitor 310, a keyboard 311, a mouse 312, and the like coupled to the I/O 307. A compact disk/digital versatile disk (CD/DVD) drive or the like may be coupled to the I/O 307.

The functions of the river information processing apparatus 3 described in FIG. 1 are implemented by executing a predetermined program in the CPU 302. The program may be acquired via a recording medium, maybe acquired via a network, or may be embedded in a ROM.

OPERATIONS

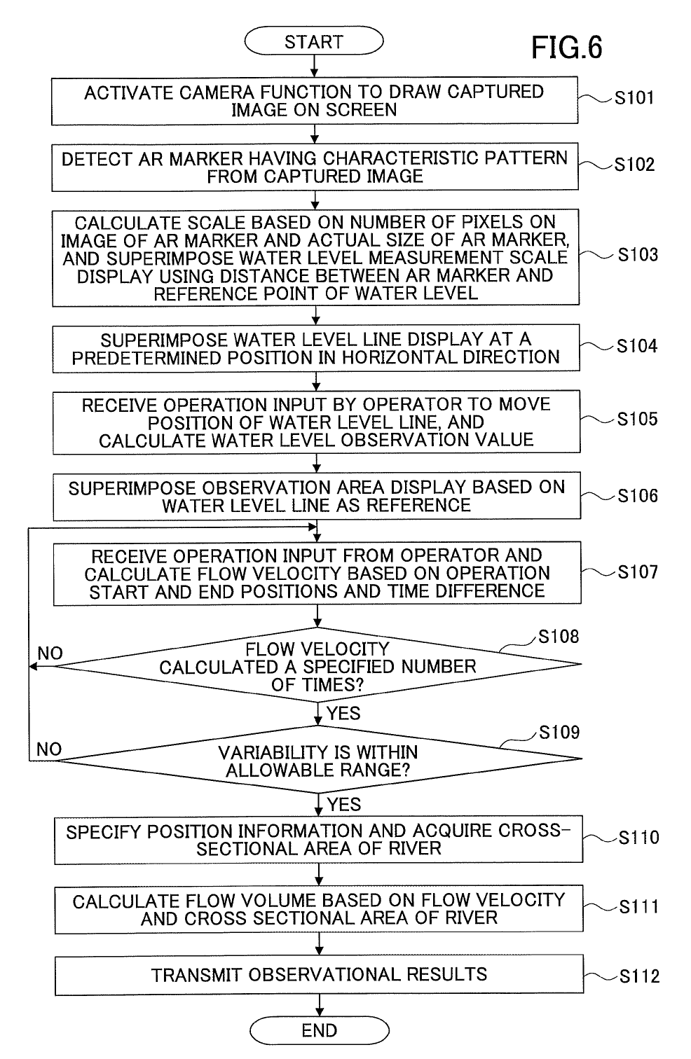

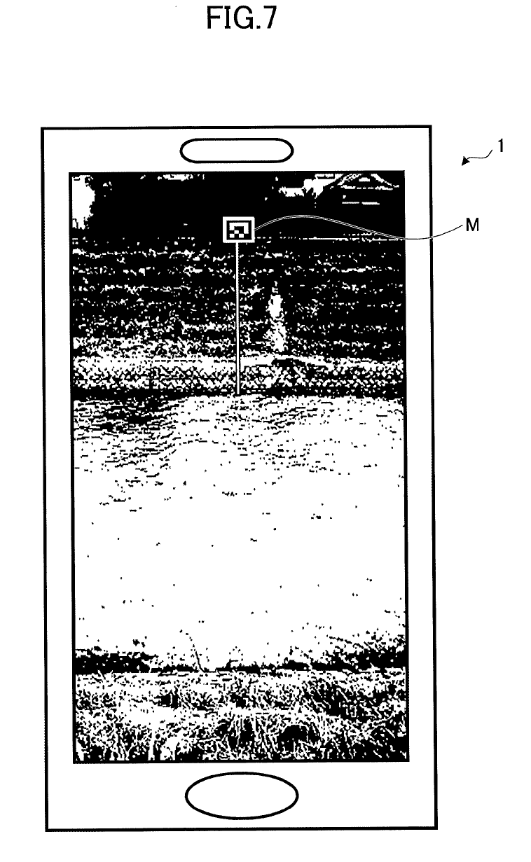

FIG. 6 is a flowchart illustrating a process example according to the embodiment. In FIG. 6, upon activating a hydrologic application or the like to start a process on the terminal 1, the captured image acquisition unit 101 activates a camera function to render the captured image on a screen (step S101). FIG. 7 depicts a screen example of the terminal 1 in this condition, and an AR marker M is imaged together with a water surface of a river.

Referring back to FIG. 6, the AR marker detector 102 detects an AR marker having a characteristic pattern from the captured image with reference to AR marker management information (see FIG. 3) (step S102).

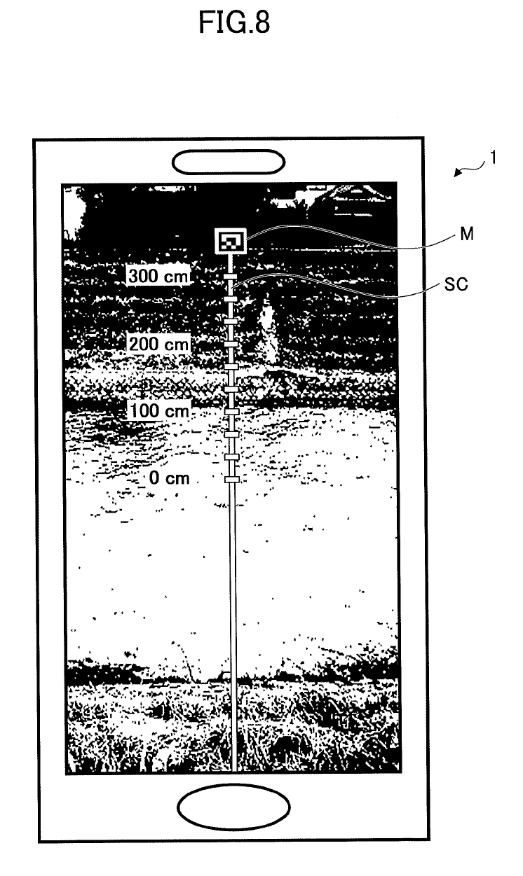

Next, the scale calculator 103 calculates a scale based on the number of pixels on the image of the AR marker and the actual size of the AR marker, and the water level scale rendering unit 104 displays the water level measurement scale display superimposed on the screen using the distance between the AR marker and the reference point of the water level (step S103). FIG. 8 depicts a screen example of the terminal 1 in this condition, and a scale display SC with calibrations is displayed downward from the lower end of the AR marker M. Water level values “300 cm”, “200 cm” and “0 cm” are attached to the calibrations at predetermined intervals. “0 cm” corresponds to the reference point of the water level.

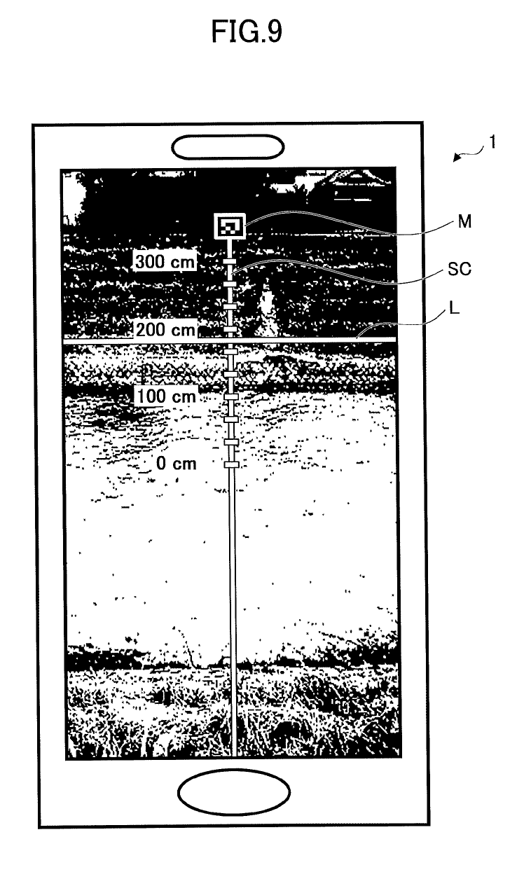

Referring back to FIG. 6, the water level line rendering unit 105 subsequently displays the water level line display superimposed at a predetermined position in the horizontal direction (step S104). FIG. 9 depicts a screen example of the terminal 1 in this condition, and a water level line display L is displayed slightly below the water position of “200 cm”.

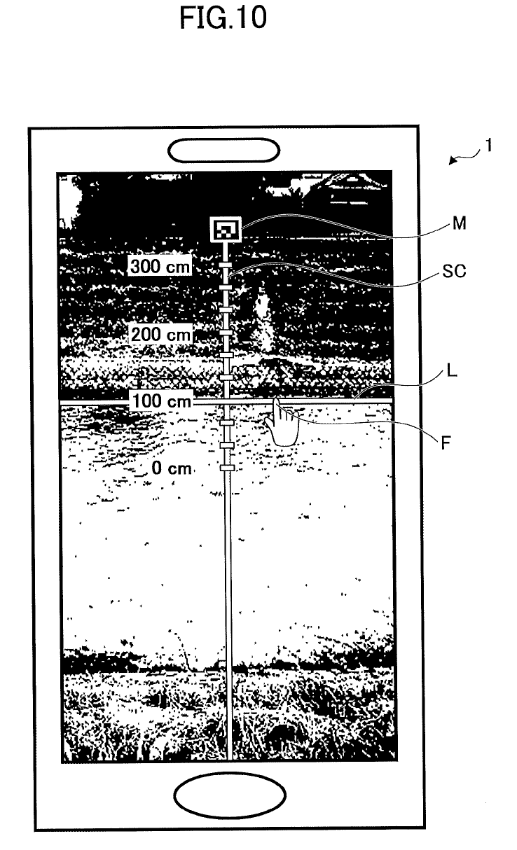

Referring back to FIG. 6, the operation input unit 107 subsequently receives an operation input such as a tap by the operator to move the water level line to that tapped position, and calculates a water level observation value (step S105). FIG. 10 illustrates a screen example of the terminal 1 in this condition, and the position corresponding to the water position “100 cm” is tapped with a finger F of the operator, re-rendering the water level line display L at that tapped position. In this case, the water level observation value is “100 cm”.

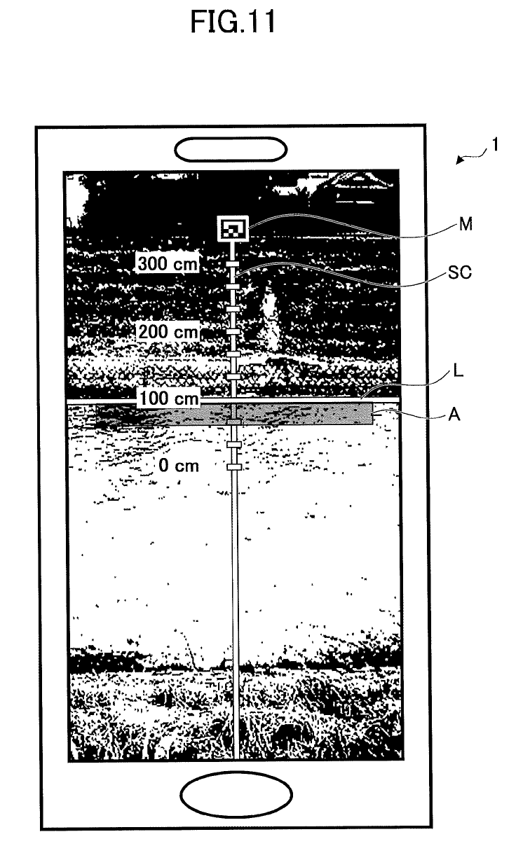

Referring back to FIG. 6, the operation area rendering unit 106 subsequently displays an observation area display superimposed based on the water level line as a reference (step S106). FIG. 11 depicts a screen example of the terminal 1 in this state, and a rectangular observation region display A is rendered below the water level line display L.

Referring back to FIG. 6, the operation input unit 107 receives an operation input from the operator, the distance calculator 108 calculates the travel distance from the operation start and end positions at which the operation input is performed, and the flow velocity calculator 109 calculates the flow velocity based on the travel distance and the time difference between the operation inputs (step S107). That is, the flow velocity calculator 109 calculates the flow velocity (speed) by dividing the travel distance by the time difference of the operation inputs. Note that an operation input such as a swipe by the operator is performed by targeting a floating object such as debris flowing through the observation area display part as the target.

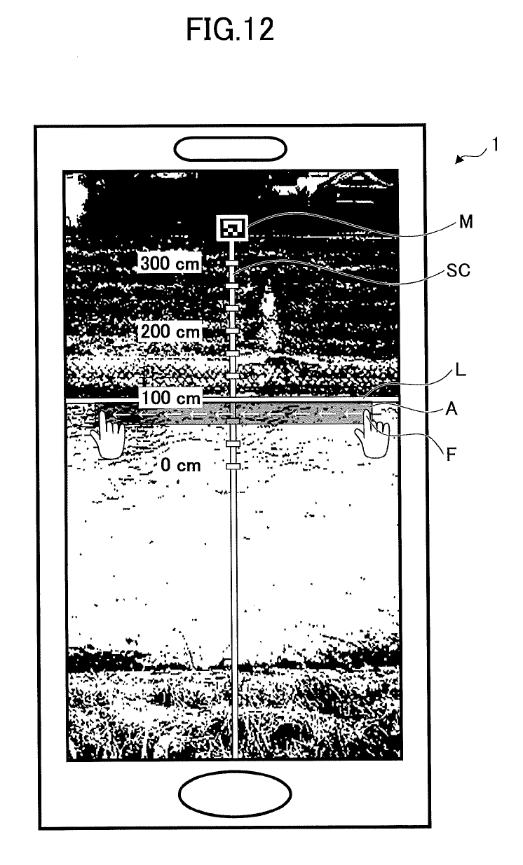

As the operation input in this case, the following implementation is assumed.
Swipe operation on the observation area display (drag operation). In this case, a touch start point corresponds to the travel start point, and a touch end point corresponds to the travel end point. FIG. 12 depicts a condition of a swipe operation performed by the finger F of the operator along an observation area display A.
Two touch operations on the observation area display. In this case, a first touch point corresponds to the travel start point, and a second touch point corresponds to the travel end point. In FIG. 12, it is assumed that the swipe operation is performed without leaving the finger F from the screen. However, in the case of two touch operations, a touch is made at the operation start position, the finger is then separated from the screen, the touch is made again at the operation end position, and the finger is then separated from the screen again.

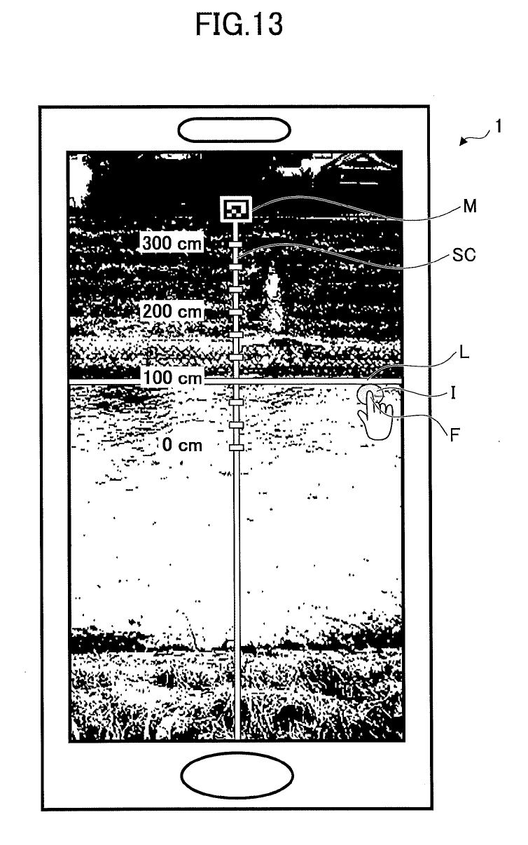

Instead of the observation area display, as depicted in FIG. 13, a symbol display I capable of a slide operation (drag operation) may be displayed, and the start of the travel and the end of the travel may be received as the operation input.

Referring back to FIG. 6, the flow velocity calculator 109 or the distance calculator 108 determines whether the flow velocity has been calculated a specified number of times (e.g., three times) (step S108). In a case where the flow velocity has not been calculated as above (No in step S108), the process is repeated from receiving the operation input (step S107). The identification of the calculation of the specified number of times is to secure the accuracy of measurement.

Further, in a case where the flow velocity is calculated a specified number of times (Yes in step S108), the flow velocity calculator 109 or the distance calculator 108 determines whether the variability in the calculated flow velocity is within the allowable range (step S109). In a case where the variability in the calculated flow velocity is not within the allowable range (No in step S109), the process is repeated from receiving the operation input (step S107). In this case, calculation results determined to be relatively abnormal are eliminated. The identification of the variability is to secure the accuracy of measurement by eliminating abnormal values.

Subsequently, the cross-sectional area acquisition unit 110 acquires the position information of the terminal 1 by the GPS function or the like, specifies the position information, makes a request to the river information processing apparatus 3, and acquires a cross-sectional area of the river (step S110).

Next, the flow volume calculator 111 calculates the flow volume based on the calculated flow velocity and the acquired cross sectional area of the river (step S111). That is, the flow volume calculator 111 calculates a flow volume by multiplying the flow velocity by the cross-sectional area of the river.

Subsequently, the information transmitter 112 transmits the calculated flow volume, the position information of the measurement, the measurement date and time, and the image of the river at the time of measurement as required to the river information processing apparatus 3, as information of the measurement result.

MODIFICATION

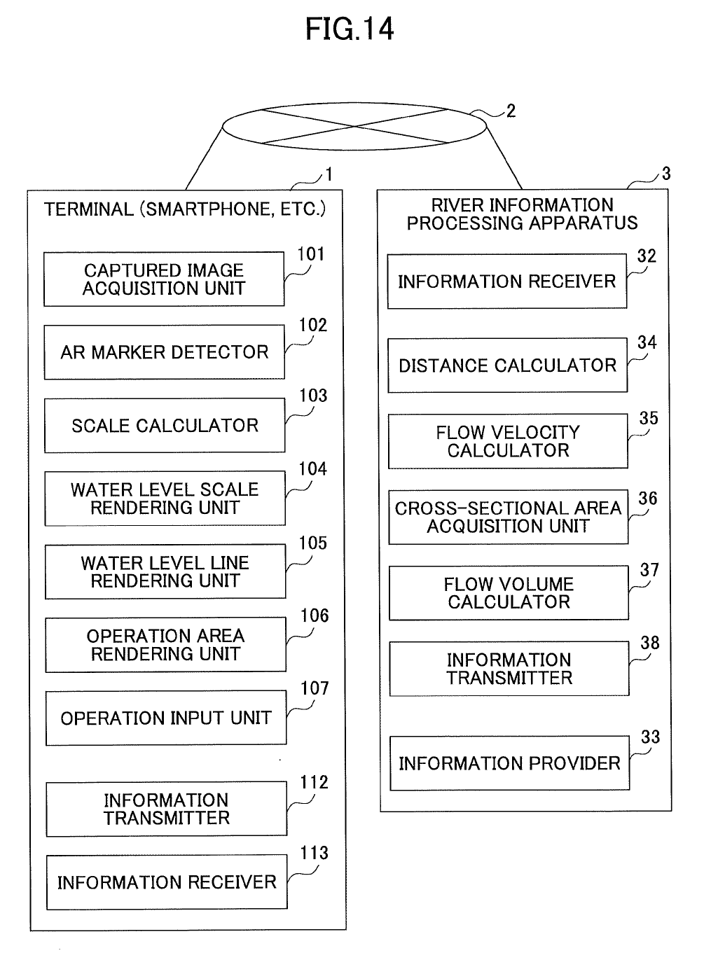

FIG. 14 is a diagram illustrating another configuration example of a system according to a modification of the embodiment. According to this system, the terminal 1 is configured to image a river, display a screen, and receive an operation input whereas the river information processing apparatus 3 is configured to calculate a distance, flow velocity, and flow volume.

In FIG. 14, the terminal 1 includes a captured image acquisition unit 101, an AR marker detector 102, a scale calculator 103, a water level scale rendering unit 104, a water level line rendering unit 105, an operation area rendering unit 106, an operation input unit 107, an information transmitter 112, and an information receiver 113. The river information processing apparatus 3 includes an information receiver 32, an information provider 33, a distance calculator 34, a flow velocity calculator 35, a cross-sectional area acquisition unit 36, and a flow volume calculator 37.

Compared to the configuration depicted in FIG. 1, the distance calculator 108, the flow velocity calculator 109, the cross-sectional area acquisition unit 110, and the flow volume calculator 111, which are disposed in the terminal 1 of the embodiment, correspond to the distance calculator 34, the flow velocity calculator 35, a cross-sectional area acquisition unit 36, and a flow volume calculator 37 disposed in the river information processing apparatus 3 in the system of the modification. The above components of the terminal 1 of the embodiment function in similar manners as the respective components of the river information processing apparatus 3. In addition, the information transmitter 112 is configured to function not to transmit the observation results but to transmit received operation input information to the river information processing apparatus 3. Further, the terminal 1 includes the newly disposed information receiver 113 configured to receive, from the river information processing apparatus 3, information indicating that operation input is required again for the river information processing apparatus, in a case where operation input is determined to be required again for the river information processing apparatus 3.

In this modification, the river information processing apparatus 3 no longer requires the cross-sectional area provider 31, and newly includes an information transmitter 38 configured to transmit to the terminal 1 information indicating that the operation input is required again.

In the operations, among steps in the process depicted in FIG. 6, the terminal 1 is responsible for steps up to S107 where the operation input is received from the operator and the received operation input information is transmitted to the river information processing apparatus 3, whereas the river information processing apparatus 3 is responsible for step S107 and steps subsequent.

According to one embodiment, a distance calculation apparatus having a terminal provided with an imaging device and a touch panel includes:

a detector configured to detect a first operation and a second operation on the touch panel in a display mode in which a captured image captured by the imaging device is displayed and a scale is set in the captured image; and

a calculator configured to execute a distance calculation process using the scale, based on a position of the first operation and a position of the second operation, to calculate a distance between a position on the captured image corresponding to the position of the first operation and a position on the captured image corresponding to the position of the second operation.

In the distance calculation apparatus, the first and second operations are different touch operations on the touch panel.

In the distance calculation apparatus, the first operation is a touch start operation on the touch panel and the second operation is a touch end operation continuing from the touch start operation on the touch panel.

In the distance calculation apparatus, a line is displayed on the captured image, and the first and second operations are performed on the line displayed on the captured image.

In the distance calculation apparatus, the first operation is a start operation to start moving a display position of a display symbol on the touch panel, and the second operation is an end operation to end moving the display position of the display symbol on the touch panel.

In the distance calculation apparatus, a display indicating the scale is superimposed on the captured image.

In the distance calculation apparatus, a value is calculated by dividing the calculated distance by the time difference between timing of the first operation and timing of the second operation to calculate velocity based on the calculated distance.

In the distance calculation apparatus, captured images captured by the imaging device are sequentially updated to display the updated captured images.

According to one embodiment, a distance calculation apparatus having a terminal provided with an imaging device and a touch panel includes:

a detector configured to detect a first operation and a second operation on the touch panel in a display mode in which a captured image captured by the imaging device is displayed and a scale is set in the captured image; and

a calculator configured to execute a distance calculation process using the scale, based on the scale, a position of the first operation, and a position of the second operation to transmit information including the position of the first operation and the position of the second operation to an information processing apparatus configured to calculate a distance between a position on the captured image corresponding to the position of the first operation and a position on the captured image corresponding to the position of the second operation.

According to one embodiment, a flow volume measuring apparatus includes:

a display unit configured to display an image of a river on the screen;

an output unit configured to receive an input of a line along a water level of the displayed river to output, on the screen, an area included in a predetermined range from the line on the screen; and

a specification unit configured to acquire operation information from a user with respect to the area to identify a flow volume of the river based on the operation information and cross-sectional area information of the river.

In the flow volume measuring apparatus, the operation information is information on a travel distance and a travel time of a slide operation with respect to the area.

In the flow volume measuring apparatus, the travel distance is a distance travelled in a direction parallel to a water level line.

In the flow volume measuring apparatus. In the flow volume measuring apparatus, at least one of processes of (a) changing a color of the area and outputting the changed color of the area, (b) highlighting the area, and (c) encircling the area and outputting the encircled area, is executed upon outputting the area.

In the flow volume measuring apparatus, the cross-sectional area information of the river is obtained based on position information of a terminal displaying the image of the river.

OVERVIEW

As described above, according to the present embodiment, the distance may be calculated by processing on the terminal. Subsequently, based on the calculated distance, the velocity may be calculated, and the flow volume and the like may be calculated.

### ADVANTAGEOUS EFFECT OF THE INVENTION

In one aspect, a distance is calculated by processing on a terminal.

The preferred embodiments are described above. The embodiments of the present invention are illustrated with specific examples; however, the present invention is not limited to these examples, and various alterations or changes may be made without departing from the gist and the scope of the claims of the present invention. Specifically, the present invention shall not be construed as being limited to details of the specific examples and accompanying renderings thereof.

With respect to the above-described description, the following terms are further disclosed.

The terminal 1 is an example of a “terminal”. The operation input unit 107 is an example of a “detector”. The distance calculator 108 and the distance calculator are examples of a “calculator”. The information transmitter 112 is an example of a “transmitter”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A distance calculation method executed by a computer with respect to a terminal having an imaging device and a touch panel, the distance calculation method comprising:
detecting a first operation and a second operation on the touch panel in a display mode in which a captured image captured by the imaging device is displayed and a scale is set in the captured image; and
executing the distance calculation process using the scale, based on a position of the first operation and a position of the second operation, to calculate a distance between a position on the captured image corresponding to the position of the first operation and a position on the captured image corresponding to the position of the second operation.

2. The distance calculation method as claimed in claim 1, wherein
the first and second operations are different touch operations on the touch panel.

3. The distance calculation method as claimed in claim 1, wherein
the first operation is a touch start operation on the touch panel and the second operation is a touch end operation continuing from the touch start operation on the touch panel.

4. The distance calculation method as claimed in claim 1, further comprising:
displaying a line on the captured image, wherein the first and second operations are performed on the line displayed on the captured image.

5. The distance calculation method as claimed in claim 1, wherein
the first operation is a start operation to start moving a display position of a display symbol on the touch panel and the second operation is an end operation to end moving the display position of the display symbol on the touch panel.

6. The distance calculation method as claimed in claim 1, further comprising:
displaying a display indicating the scale that is superimposed on the captured image.

7. The distance calculation method as claimed in claim 1, further comprising:
calculating a value by dividing the calculated distance by the time difference between timing of the first operation and timing of the second operation to calculate velocity based on the calculated distance.

8. The distance calculation method as claimed in claim 1, further comprising:
sequentially updating captured images captured by the imaging device to display the updated captured images.

9. A flow volume measuring method executed by a computer, the flow volume measuring method comprising:
displaying an image of a river on the screen;
receiving an input of a line along a water level of the displayed river;
outputting, on the screen, an area included in a predetermined range from the line;
acquiring operation information from a user with respect to the area; and
identifying a flow volume of the river based on the operation information and cross-sectional area information of the river.

10. The flow volume measuring method as claimed in claim 9, wherein
the operation information is information on a travel distance and a travel time of a slide operation with respect to the area.

11. The flow volume measuring method as claimed in claim 10, wherein
the travel distance is a distance travelled in a direction parallel to a water level line.

12. The flow volume measuring method as claimed in claim 9, further comprising:
at least one of
(a) changing a color of the area and outputting the changed color of the area,
(b) highlighting the area, and
(c) encircling the area and outputting the encircled area,
upon outputting the area.

13. The flow volume measuring method as claimed in claim 9, wherein
the cross-sectional area information of the river is obtained based on position information of a terminal displaying the image of the river.

14. A distance calculation apparatus having a terminal provided with an imaging device and a touch panel, the distance calculation apparatus comprising:
a memory storing a set of instructions of a distance calculation program; and
one or more processors programmed to execute a distance calculation process including
detecting a first operation and a second operation on the touch panel in a display mode in which a captured image captured by the imaging device is displayed and a scale is set in the captured image; and
executing the distance calculation process using the scale, based on a position of the first operation and a position of the second operation, to calculate a distance between a position on the captured image corresponding to the position of the first operation and a position on the captured image corresponding to the position of the second operation.

15. A flow volume measuring apparatus comprising:
a memory storing a set of instructions of a flow volume measuring program; and
one or more processors programmed to execute a flow volume measuring process including
displaying an image of a river on the screen;
receiving an input of a line along a water level of the displayed river;
outputting, on the screen, an area included in a predetermined range from the line on the screen;
acquiring operation information from a user with respect to the area; and
identifying a flow volume of the river based on the operation information and cross-sectional area information of the river.
